(19) United States
(12) Patent Application Publication
(10) Pub. No.: US 2025/0245318 A1
(43) Pub. Date: Jul. 31, 2025

(54) ISOLATED TEST ENVIRONMENT FOR RANSOMWARE ANALYSIS

(71) Applicant: Mimic Networks, Inc., Palo Alto, CA (US)

(72) Inventors: Iain Donaldson, Maidenhead (GB); Scott Young, Ashburn, VA (US); Timothy Worsley, Snoqualmie, WA (US); Michael Burtscher, Chicago, IL (US); Chi Zhang, Brookline, MA (US); Kirby Kuehl, Portland, OR (US); Carl Schroeder, Los Altos, CA (US); Adam Woodbeck, White Lake, MI (US)

(73) Assignee: Mimic Networks, Inc., Palo Alto, CA (US)

(21) Appl. No.: 19/040,454

(22) Filed: Jan. 29, 2025

Related U.S. Application Data
(60) Provisional application No. 63/626,467, filed on Jan. 29, 2024.

(51) Int. Cl. G06F 21/53; G06F 21/55; G06F 21/56

(52) U.S. Cl. CPC G06F 21/53; G06F 21/552; G06F 21/568

(57) ABSTRACT

Techniques are provided for an isolated test environment for ransomware analysis. One or more enterprise applications are assigned to one or more server systems to be provisioned in an isolated test environment. An enterprise replica is generated in the isolated test environment by provisioning the one or more server systems and deploying the one or more enterprise applications on the one or more server systems. A kernel monitoring component is deployed on the one or more server systems in the isolated test environment. The kernel monitoring component is configured to generate kernel telemetry data for a plurality of system calls initiated by processes executing on the one or more server systems. A selected ransomware variant is deployed in the isolated test environment. An effect of the selected ransomware variant on the enterprise replica is determined based on analyzing the kernel telemetry data.

CROSS-REFERENCE TO RELATED APPLICATIONS; BENEFIT CLAIM

This application claims the benefit of U.S. Provisional Application Ser. No. 63/626,467, filed Jan. 29, 2024, the entire contents of which are hereby incorporated by reference as if fully set forth herein, under 35 U.S.C. § 119 (e).

### FIELD OF THE DISCLOSURE

The present disclosure generally relates to security techniques, and relates more specifically to testing the effect of ransomware on replica server systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely based on their inclusion in this section.

Ransomware attacks pose a significant threat to organizations, disrupting operations and compromising sensitive data. To learn more about ransomware threats, security companies use various tactics. For example, researchers may perform reverse engineering and/or static code analysis to examine ransomware programs. Researchers may also analyze real-world attack campaigns, or otherwise track ransomware variants. Researchers may also execute ransomware samples in sandboxed environments to observe its behaviors and effects on model systems. However, these sandboxed executions typically lack the complexity of real-world systems and typically do not capture the vulnerabilities of a particular organization's computer system. There is a need for techniques to evaluate the effect of ransomware on an organization's production system in a meaningful way.

### SUMMARY

The appended claims may serve as a summary.

### BRIEF DESCRIPTION OF THE DRAWINGS

In the drawings:

FIG. 1 illustrates a computer system that includes a ransomware defense system in an example embodiment.

FIG. 2 illustrates a protected computer in an example embodiment.

FIG. 3 illustrates a computer system that includes a ransomware testing system and an isolated test environment in an example embodiment.

FIG. 4 illustrates a computer system that includes a production deployment analysis system configured to analyze production kernel telemetry data to configure an enterprise replica in an example embodiment.

FIG. 5 illustrates a computer system that includes a test deployment analysis system configured to analyze test kernel telemetry data to configure an enterprise replica in an example embodiment.

FIG. 6 is a flow diagram of a process for analyzing the effect of ransomware on an enterprise replica in an isolated test environment in an example embodiment.

FIG. 7 illustrates a computer system upon which an embodiment may be implemented.

While each drawing figure illustrates a particular embodiment for the purpose of providing a clear example, other embodiments may omit, add to, reorder, or modify any of the elements shown in the drawing figures. Unless otherwise specified, aspects disclosed with respect to an embodiment of an element in a figure may optionally be applied to another embodiment of the element in another figure. For purposes of illustrating clear examples, one or more figures may be described with reference to one or more other figures. However, using the particular arrangement illustrated in such other figure/s is not required in other embodiments.

### DETAILED DESCRIPTION

In the following description, numerous specific details are set forth in order to provide a thorough understanding of the subject matter of the present application. It will be apparent, however, to a person of ordinary skill that embodiments may be practiced without incorporating all aspects of the specific details described herein. The detailed description that follows describes exemplary embodiments and the features disclosed are not intended to be limited to the expressly disclosed combination(s). Therefore, unless otherwise noted, features disclosed herein may be combined to form additional combinations that were not otherwise shown for purposes of brevity.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other, and does not imply an ordering, timing, or any other characteristic of the referenced items unless otherwise specified; the term “and/or” as used herein refers to and encompasses any and all possible combinations of one or more of the associated listed items; that the terms “includes”, “including”, “comprises”, and/or “comprising” specify the presence of stated features but do not preclude the presence or addition of one or more other features. Unless otherwise specified: “such as” is intended to mean “such as but not limited to”; and examples are intended to be nonlimiting.

As used herein, the term “component” refers to any element, module, device, part, hardware, software, firmware, or any combination thereof. As an alternative and/or addition, a component may comprise specialized circuitry and/or or mechanical assemblies designed to perform specific functions. A component may be a standalone component, work in conjunction with one or more other components, contain one or more other components, and/or belong to one or more other components. A component may perform specific functions, interact with other components, provide structure, and/or achieve certain operations.

As used herein, the terms “coupled” refers to a connection between two components, which may be direct or indirect, permitting additional intermediary components, elements, structures, or mechanisms between the coupled components. Such connections may encompass, but are not limited to, communicative connections (e.g., electronic, optical, wireless, and/or other communication pathways), mechanical connections, electromagnetic connections, and/or any other form of functional, operative, or interactive association.

As used herein, the term “system” refers to mechanical components, hardware, and/or software stored in, or coupled with, a memory and/or one or more processors on one or more computers. As an alternative and/or addition, a component may comprise specialized circuitry and/or or mechanical assemblies designed to perform specific functions. A system may be a standalone component, work in conjunction with one or more other systems, contain one or more other systems, and/or belong to one or more other systems. A system may be a computer system, mechanical system, or an integrated system that combines both mechanical and computational elements.

As used herein, the term “computer” refers to any apparatus, electronic device, or system capable of processing data, executing instructions, and/or performing calculations. A computer may include one or more controllers, processors, memory, input/output interfaces, storage devices, and/or any combination thereof. The term encompasses both virtual computers and/or hardware computers, including desktop computers, laptop computers, server computers, edge devices, cloud-based systems, embedded systems, controllers, microcontrollers, and other programmable devices. It applies to standalone and/or networked devices and may include software, firmware, and/or hardware for computational functions.

As used herein, the term “computer system” refers to one or more computers, such as one or more hardware computers, virtual computers, and/or computing devices. For example, a computer system may be, or may include, one or more server computers, desktop computers, laptop computers, mobile devices, special-purpose computing devices with a processor, cloud-based computers, cloud-based clusters of computers, virtual machine instances, and/or other computing devices. A computer system may include another computer system, and a computing device may belong to two or more computer systems. Any reference to a “computer system” may mean one or more computers, unless expressly stated otherwise. When a computer system performs an action, the action is performed by one or more computers of the computer system.

As used herein, the term “device” refers to a mechanical system, a computer system, hardware, and/or software stored in, or coupled with, a memory and/or one or more processors on one or more computers. As an alternative and/or addition, a device may comprise specialized circuitry and/or or mechanical assemblies designed to perform specific functions. A device may be a standalone device, work in conjunction with one or more other devices, contain one or more other devices, and/or belong to one or more other devices.

A “client” refers to a combination of integrated software components and an allocation of computational resources, such as memory, a computing device, and/or processes on a computing device for executing the integrated software components. The combination of the software and the computational resources is configured to interact with one or more servers over a network, such as the Internet. A client may refer to either the combination of components on one or more computers, or the one or more computers (also referred to as “client computing devices”).

A “server” refers to a combination of integrated software components and an allocation of computational resources, such as memory, a computing device, and/or processes on the computing device for executing the integrated software components. The combination of the software and the computational resources is dedicated to providing a particular type of function on behalf of clients of the server. A server may refer to either the combination of components on one or more computing devices, or the one or more computing devices (also referred to as a “server system”). A server system may include multiple servers; that is, a server system may include a first computing device and a second computing device, which may provide the same or different functionality to the same or different set of clients.

### General Overview

This document generally describes systems, methods, devices, and other techniques for ransomware analysis in an isolated test environment. A ransomware testing system may be configured to generate an enterprise replica in an isolated test environment and deploy a ransomware variant in the isolated test environment to determine the effect of the ransomware variant on the enterprise replica. A kernel monitoring component may be deployed on one or more server systems of the enterprise replica. The kernel monitoring component is configured to generate kernel telemetry data for a plurality of system calls. The effect of the ransomware variant on the enterprise replica may be determined based on analyzing the kernel telemetry data. The ransomware testing system may optionally generate the enterprise replica with a ransomware defense system to determine the effectiveness of the ransomware defense system in protecting the enterprise replica from the ransomware variant.

The enterprise replica may be generated based on kernel telemetry data, such as kernel telemetry data collected in a live production environment and/or kernel telemetry data collected in an application evaluation environment. The kernel telemetry data may be used to determine resource dependencies in order to generate the enterprise replica. In some embodiments, the enterprise replica may include an enterprise application and application dependencies identified by analyzing the kernel telemetry data collected in the live production environment or the application evaluation environment.

As used herein, the term “ransomware agent” refers to any entity, such as software, hardware, organizations, human actors, and/or any combination thereof, that seizes, encrypts, alters, disrupts, and/or otherwise restricts access to one or more resources, data, systems, networks, devices, and/or other assets. For example, a ransomware agent may include a human actor entering commands to carry out activity performed by a ransomware agent. Activity performed by a ransomware agent to carry out its objectives is referred to herein as “ransomware activity.” As used herein, the term “ransomware” refers to ransomware agent/s comprising a computer program, application, and/or other executable code. A ransomware agent may condition the restoration of access, functionality, or avoidance of further harm upon fulfilling one or more demands. For example, ransomware agents may demand payment in exchange for encryption keys necessary for decryption. Ransomware agents may also exfiltrate data from the computer system, and may demand payment in exchange for not releasing the exfiltrated data.

Ransomware is explicitly referenced in the context of one or more embodiments. It is to be understood, however, that the techniques described herein may be adapted to other forms of malicious activity, malicious agents, and/or malware without departing from the spirit or the scope of the disclosure. For example, one or more techniques described herein may be adapted to patterns of kernel-level behavior that are consistent with processes executed under the control of other forms of malicious activity, malicious agents, and/or malware.

One aspect of the disclosure is directed to a method comprising: assigning one or more enterprise applications to one or more server systems to be provisioned in an isolated test environment; generating an enterprise replica in the isolated test environment by provisioning the one or more server systems and deploying the one or more enterprise applications on the one or more server systems in the isolated test environment; deploying a kernel monitoring component on the one or more server systems in the isolated test environment, the kernel monitoring component configured to generate kernel telemetry data for a plurality of system calls initiated by processes executing on the one or more server systems; deploying a selected ransomware variant in the isolated test environment; and determining an effect of the selected ransomware variant on the enterprise replica based on analyzing the kernel telemetry data; wherein the method is performed by one or more processors.

In some examples, the kernel telemetry data associates, for each system call of the plurality of system calls, a process invoking the system call, an operation type of the system call, and a target of the system call.

In some examples, the method further includes: selecting one or more application parameters for the one or more enterprise applications; wherein generating the enterprise replica is based on the one or more application parameters.

In some examples, the method further includes: selecting one or more server parameters for the one or more server systems; wherein the one or more server systems are provisioned based on the one or more server parameters.

In some examples, the method further includes: generating a second enterprise replica in a second isolated test environment by provisioning the one or more server systems and deploying the one or more enterprise applications with at least one configuration difference from the enterprise replica; deploying the kernel monitoring component and the selected ransomware variant in the second isolated test environment, the kernel monitoring component configured to generate second kernel telemetry data for a second plurality of system calls initiated by processes executing on the one or more server systems in the second isolated test environment; determining a second effect of the selected ransomware variant on the enterprise replica in the second isolated test environment based on analyzing the second kernel telemetry data; and identifying a set of differences between the effect and the second effect that are attributable to the at least one configuration difference.

As an alternative and/or addition, the at least one configuration difference comprises deploying a ransomware defense component on at least one of the one or more server systems in the second isolated test environment.

As an alternative and/or addition, the at least one configuration difference includes at least one of: one or more different application parameters for the one or more enterprise applications; and one or more different system parameters for the one or more server systems.

In some examples, the method further includes: deploying a ransomware defense component on at least one of the one or more server systems in the isolated test environment, the ransomware defense component configured to: analyze the kernel telemetry data; based on analyzing the kernel telemetry data, determine that a particular process executed under control of a ransomware agent; and in response to determining that the particular process executed under control of the ransomware agent, initiate one or more response measures.

In some examples, the method further includes: determining one or more resource dependencies of the one or more enterprise applications; obtaining a set of resources to deploy in the isolated test environment based on the one or more resource dependencies; and deploying the set of resources in the isolated test environment.

As an alternative and/or addition, determining the one or more resource dependencies comprises: deploying the kernel monitoring component on one or more production server systems running the one or more applications, wherein the kernel monitoring component generates production kernel telemetry data for a third plurality of system calls initiated by processes executing on the one or more production server systems; wherein determining the one or more resource dependencies is based on the production kernel telemetry data.

As an alternative and/or addition, determining the one or more resource dependencies comprises: deploying one or more test server systems running the one or more applications in an application evaluation environment; and deploying the kernel monitoring component on the one or more test server systems, wherein the kernel monitoring component generates test kernel telemetry data for a fourth plurality of system calls initiated by processes executing on the one or more test server systems; wherein determining the one or more resource dependencies is based on the test kernel telemetry data.

In some examples, the method further includes: deploying environment monitoring instrumentation in the isolated test environment, the environment monitoring instrumentation configured to collect resource consumption telemetry data corresponding to resource usage by the kernel monitoring component; and determining an effect of the kernel monitoring component on the enterprise replica based on the resource consumption telemetry data.

One aspect of the disclosure is directed to a computer system comprising: one or more processors; at least one memory storing one or more instructions which, when executed by the one or more processors, cause the one or more processors to: assign one or more enterprise applications to one or more server systems to be provisioned in an isolated test environment; generate an enterprise replica in the isolated test environment by provisioning the one or more server systems and deploying the one or more enterprise applications on the one or more server systems in the isolated test environment; deploy a kernel monitoring component on the one or more server systems in the isolated test environment, the kernel monitoring component configured to generate kernel telemetry data for a plurality of system calls initiated by processes executing on the one or more server systems; deploy a selected ransomware variant in the isolated test environment; and determine an effect of the selected ransomware variant on the enterprise replica based on analyzing the kernel telemetry data.

In some examples, the kernel telemetry data associates, for each system call of the plurality of system calls, a process invoking the system call, an operation type of the system call, and a target of the system call.

In some examples, the instructions, when executed by the one or more processors, cause the one or more processors to: generate a second enterprise replica in a second isolated test environment by provisioning the one or more server systems and deploying the one or more enterprise applications with at least one configuration difference from the enterprise replica; deploy the kernel monitoring component and the selected ransomware variant in the second isolated test environment. the kernel monitoring component configured to generate second kernel telemetry data for a second plurality of system calls initiated by processes executing on the one or more server systems in the second isolated test environment; determine a second effect of the selected ransomware variant on the enterprise replica in the second isolated test environment based on analyzing the second kernel telemetry data; and identify a set of differences between the effect and the second effect that are attributable to the at least one configuration difference.

As an alternative and/or addition, the at least one configuration difference comprises deploying a ransomware defense component on at least one of the one or more server systems in the second isolated test environment.

In some examples, the instructions, when executed by the one or more processors, cause the one or more processors to: deploy a ransomware defense component on at least one of the one or more server systems in the isolated test environment, the ransomware defense component configured to: analyze the kernel telemetry data; based on analyzing the kernel telemetry data, determine that a particular process executed under control of a ransomware agent; and in response to determining that the particular process executed under control of the ransomware agent, initiate one or more response measures.

In some examples, the instructions, when executed by the one or more processors, cause the one or more processors to: determine one or more resource dependencies of the one or more enterprise applications; obtain a set of resources to deploy in the isolated test environment based on the one or more resource dependencies; and deploy the set of resources in the isolated test environment.

As an alternative and/or addition, determining the one or more resource dependencies comprises: deploying the kernel monitoring component on one or more production server systems running the one or more applications, wherein the kernel monitoring component generates production kernel telemetry data for a second plurality of system calls initiated by processes executing on the one or more production server systems; wherein determining the one or more resource dependencies is based on the production kernel telemetry data.

As an alternative and/or addition, determining the one or more resource dependencies comprises: deploying one or more test server systems running the one or more applications in an application evaluation environment; and deploying the kernel monitoring component on the one or more test server systems, wherein the kernel monitoring component generates test kernel telemetry data for a third plurality of system calls initiated by processes executing on the one or more test server systems; wherein determining the one or more resource dependencies is based on the test kernel telemetry data.

In some implementations, the various techniques described herein may achieve one or more of the following advantages: ransomware executing on a computer system and/or enterprise network may be more quickly and accurately detected; robust enterprise replicas are generated, taking into account resource dependencies; ransomware testing may be performed on an enterprise replica to identify vulnerabilities specific to an enterprise system; ransomware testing may be performed for critical applications using an enterprise replica; the effectiveness of ransomware protection on specific enterprise systems and/or specific applications may be determined; ransomware defenses may be validated before deployment in a staging or production environment; ransomware behavior may be analyzed in an isolated environment; vulnerabilities in enterprise systems and/or critical applications may be detected at an early stage of development; ransomware deflection may be performed earlier and/or more effectively; the effects of ransomware execution may be prevented and/or mitigated; the accuracy of ransomware detection may be improved; and ransomware detection and deflection techniques may quickly adapt to new ransomware variants. Additional features and advantages are apparent from the specification and the drawings.

### System Overview

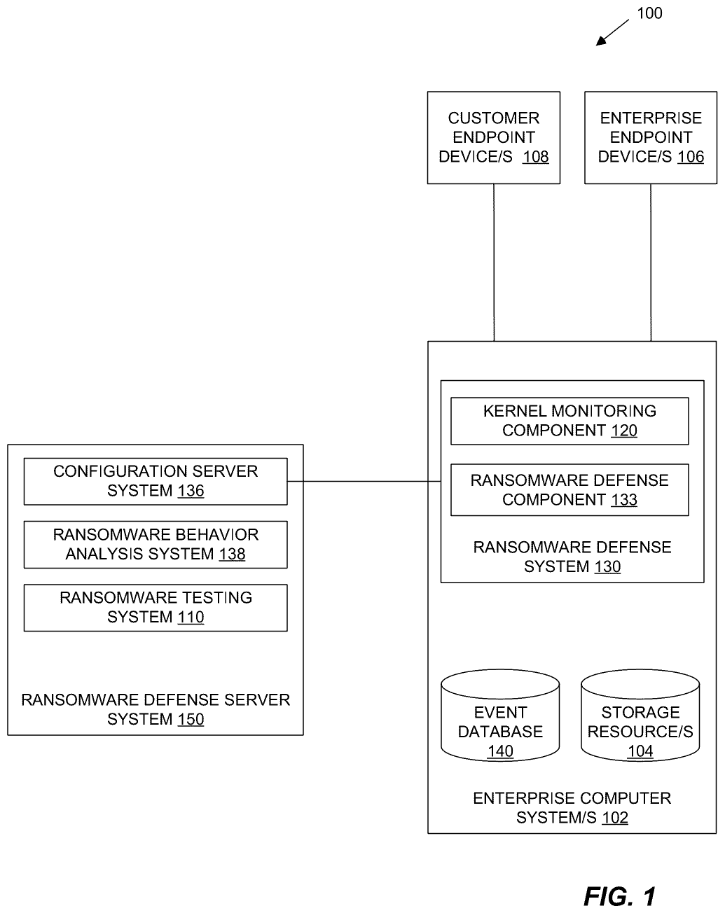

FIG. 1 illustrates a computer system that includes a ransomware defense system in an example embodiment. The computer system 100 includes a ransomware defense server system 150, an enterprise computer system 102 protected by a ransomware defense system 130, and one or more endpoint devices 106-108. While one instance is shown of the ransomware defense server system 150 and the enterprise computer system 102, the computer system 100 may include one or multiple instances.

The ransomware defense server system 150, enterprise computer system 102, and endpoint device/s 106-108 communicate over one or more networks. The network/s may include one or more local area networks (LANs) and/or one or more wide area networks, such as the Internet. The network arrangement of the ransomware defense system 130, enterprise computer system 102, and endpoint device/s 106-108 may vary.

The enterprise computer system 102 includes one or more computer systems owned by, operated by, and/or under the control of an enterprise. In some embodiments, the enterprise computer system 102 is deployed within an enterprise network, which may include one or more virtual private networks (VPNs). As an alternative and/or addition, one or more enterprise computer systems 102 may be deployed outside of an enterprise network, such as in cloud infrastructure.

The enterprise computer systems 102 may be accessed by one or more enterprise endpoint device/s 106. Enterprise endpoint device/s 106 are owned by, operated by, and/or controlled by an enterprise and/or its employees. As an alternative and/or addition, one or more enterprise computer systems 102 may be accessed by one or more customer endpoint device/s 108. For example, when the enterprise computer system 102 includes a web server system, a customer endpoint device 108 may interact with the web server system using a browser or a web-based application executing on the customer endpoint device 108. Other enterprise computer systems may also access the enterprise computer system 102.

A ransomware defense system 130 is deployed on the enterprise computer system 102. An enterprise computer system 102 on which the ransomware defense system 130 is deployed is also referred to herein as a protected enterprise computer system 102. In some embodiments, the ransomware defense system 130 is deployed on a set of selected enterprise computers, such as hardware and/or virtual computers involved in the deployment of one or more critical applications of the enterprise. The ransomware defense system 130 protects an enterprise computer system 102 from malicious actors, such as ransomware agents. The ransomware defense system 130 may be configured to detect ransomware activity and respond to the detection of ransomware activity to prevent or mitigate an attack. While enterprise computer systems are referenced in the context of one or more embodiments, it is to be understood that the techniques described herein may be adapted to analyze and/or protect any computer system without departing from the spirit or the scope of the disclosure.

The ransomware defense system 130 may include one or more components, such as but not limited to a kernel monitoring component 120 and a ransomware defense component 133. The ransomware defense system 130 and/or its components (e.g., kernel monitoring component 120, ransomware defense component 133) may refer to executable code, an application comprising the executable code, and/or an instance of the application running in memory. The components of the ransomware defense system 130 may: include distinct and/or shared processes; execute as one or multiple applications, which may each execute as one or multiple application instances; execute on one or multiple computer systems; and be deployed within any system architecture, such as but not limited to a distributed system architecture, a cloud system architecture, a virtual system architecture, and/or a traditional physical network architecture. In some embodiments, an instance of the ransomware defense system 130 is deployed on each hardware and/or virtual computer to be protected in an enterprise computer system 102. For example, an instance of the kernel monitoring component 120 may be deployed in the kernel space of each hardware and/or virtual computer, as described in greater detail hereinafter.

### Kernel Monitoring Component

The kernel monitoring component 120 monitors system calls initiated by processes executing on one or more hardware computers and/or virtual computers of the enterprise computer system 102. The kernel monitoring component 120 may generate kernel telemetry data describing one or more system calls.

In some embodiments, the kernel monitoring component 120 is configured to generate kernel telemetry data corresponding to one or more system calls. In some embodiments, the kernel telemetry data corresponding to a system call may associate a process invoking the system call, an operation type of the system call, and a target of the system call. As used herein, the term “kernel telemetry data” may refer to the kernel telemetry data as originally generated by the kernel monitoring component 120 and/or kernel telemetry data that has been processed. For example, kernel telemetry data may include kernel telemetry data that has been transformed, filtered, aggregated, formatted, or otherwise processed. The kernel telemetry data may be used by the ransomware defense system 130 to detect ransomware activity, deflect ransomware activity, evaluate the performance of one or more ransomware defenses, and/or for other related purposes, as described in greater detail hereinafter.

The kernel telemetry data describes kernel-level behavior associated with one or more system call events initiated by applications and/or processes executing on the enterprise computer system 102. For example, the kernel telemetry data may describe aspects of one or more process control calls, memory management calls, device management calls, information maintenance calls, communication calls, or any other system call. In some embodiments, the kernel telemetry data may describe file system calls that involve one or more storage resource/s 104. The storage resource/s 104 may include any form of persistent data storage, such as but not limited to physical hard disks, solid-state drives (SSDs), virtual disks, network-attached storage (NAS), cloud-based storage services, and/or any other persistent storage device or technology capable of storing digital data.

In some embodiments, the kernel telemetry data collected by the kernel monitoring component 120 may include process information, such as a process identifier (PID), a thread identifier (TID), a user or group ID associated with the process, and/or parent process information. As an alternative and/or addition, the kernel telemetry data may include an action type describing the type of operation or service being requested, such as specific process management operations, file and/or file system operations, memory management operations, inter-process communication operations, network operations, device or hardware interactions, security and permissions operations, system management operations, or other types of actions. As an alternative and/or addition, the kernel telemetry data may include one or more arguments and/or parameters passed to the system call. As an alternative and/or addition, the kernel telemetry data may include a target of the requested action, such as one or more processes, files and/or directories, memory regions, devices, network addresses, registry keys, system settings, and kernel resources. As an alternative and/or addition, the kernel telemetry data may include any other data relating to the system call.

In some embodiments, the kernel monitoring component 120 is configured to operate based on telemetry configuration settings provided by the ransomware defense server system 150. For example, the ransomware defense system 130 may obtain telemetry configuration settings from a configuration server system 136 of the ransomware defense server system 150, as described in greater detail hereinafter.

In some embodiments, the kernel monitoring component 120 makes the kernel telemetry data available to other components of the ransomware defense system 130. In some embodiments, the kernel monitoring component 120 may store the kernel telemetry data in an event database 140 configured to store kernel telemetry data describing system call events initiated at the enterprise computer system 102. As used herein, the term “database” refers to one or more data stores for at least one set of data. A data store may include one or more tangible and/or virtual data storage locations, which may or may not be physically co-located. A simple example of a database is a text file used to store information about a set of data. Another example of a database is one or more data stores that are maintained by a server that processes requests to perform operations on the database. In some embodiments, the event database 140 includes a database management system (DBMS).

In some embodiments, the kernel monitoring component 120 executing on a particular computer stores the kernel telemetry data in an event database 140 at the particular computer, making the event database 140 available to other components of the ransomware defense system 130 executing at the particular computer. As an alternative and/or addition, the kernel monitoring component 120 of a particular computer may provide kernel telemetry data directly to another component of the ransomware defense system 130 executing at the particular computer. As an alternative and/or addition, another component of the ransomware defense system 130 may process kernel telemetry data and store kernel telemetry data corresponding to one or more system call events in the event database 140. As an alternative and/or addition, an event database 140 may store kernel telemetry data corresponding to one or multiple computers. In some embodiments, the event database 140 is an endpoint of one or more data pipelines configured to extract, transform, and/or load kernel telemetry data. For example, a data pipeline for handling kernel telemetry data may be implemented by the ransomware defense system 130.

### Ransomware Defense Component

The ransomware defense component 133 of the ransomware defense system 130 is configured to detect ransomware activity based on the kernel telemetry data generated by the kernel monitoring component 120. Ransomware activity may include activity performed by a ransomware agent in carrying out its objectives. In some embodiments, the ransomware defense component 133 detects ransomware activity by determining that a particular process executed under the control of a ransomware agent based on the kernel telemetry data.

In some embodiments, the ransomware defense component 133 analyzes the kernel telemetry data to detect one or more patterns of kernel-level behavior consistent with ransomware activity, also referred to herein as hallmarks. The ransomware defense component 133 may determine that a process executed under the control of a ransomware agent by detecting a hallmark in the kernel telemetry data associated with the process. A hallmark may comprise a pattern of kernel-level behavior that is based on one system call event or a set of multiple system call events.

Hallmarks may differentiate ransomware activity from legitimate activity by legitimate applications and/or users. For example, legitimate applications and/or users generally perform a specific purpose on specific types of files with a low degree of randomness in their behavior. Furthermore, legitimate applications/users generally do not take evasive actions, and generally do not interfere with the execution of other applications, including applications that protect the enterprise computer system 102. As another example, legitimate applications/users generally take care to avoid file system errors, file corruption, and other issues that could compromise data integrity and/or system stability.

In some embodiments, one or more hallmarks correspond to ransomware activity related to files and directories. For example, one or more hallmarks may be based on patterns of kernel-level behavior related to file access and/or network activity relating to file discovery (such as crawling or scanning directories to identify files), file modification, file encryption, data exfiltration, and/or other operations related to file and/or directory access. In some embodiments, hallmarks may be based on a pattern comprising an ordered series of specific operations, such as: reading a file, writing a separate file, and then deleting the original file; reading a file, modifying the file, and then closing the file; and/or other ordered series of operations.

As an alternative and/or addition, one or more hallmarks may correspond to ransomware activity related to system configuration settings. For example, one or more hallmarks may be based on patterns of kernel-level behavior related to modification of system configuration data, including system configuration files, registry settings, security features, privileges, permissions, and/or other system configuration data. As another example, one or more hallmarks may correspond to ransomware activity related to system configuration settings. For example, one or more hallmarks may be based on patterns of kernel-level behavior related to modifying access control configurations.

As an alternative and/or addition, one or more hallmarks may correspond to ransomware activity related to process execution. For example, one or more hallmarks may be based on patterns of kernel-level behavior observable in system calls related to terminating and/or modifying processes such as critical processes, system processes, processes related to security measures, processes related to defensive mechanisms, and/or other processes. As another example, one or more hallmarks may be based on patterns of kernel-level behavior observable in system calls related to memory manipulation, code injection techniques, executing unauthorized binaries or other unauthorized code, and/or other operations related to process execution by a ransomware agent.

As an alternative and/or addition, one or more hallmarks may correspond to other ransomware activity. For example, one or more hallmarks may be based on patterns of kernel-level behavior observable in system calls related to ransom note display, ransomware propagation, ransomware activity cover-up, anti-detection behavior, anti-security behavior, and/or operations related to activity performed by a ransomware agent. As another example, one or more hallmarks may be based on patterns of kernel-level behavior associated with a particular ransomware variant.

In some embodiments, one or more hallmarks correspond to deviating from typical kernel-level behavior previously observed for a particular process. When a legitimate process deviates from its typical pattern of kernel-level behavior, the legitimate process may be acting under the control of the ransomware agent, such as due to code injection, process manipulation, API hooking, privilege escalation, and/or other techniques. In some embodiments, the kernel monitoring component 120 is configured to observe one or more legitimate processes to determine typical kernel-level behavior for a known process, and one or more hallmarks may include a pattern of deviation from the typical kernel-level behavior.

In some embodiments, the ransomware defense component 133 is configured to operate based on detection configuration settings provided by the ransomware defense server system 150. For example, the ransomware defense system 130 may obtain detection configuration settings from a configuration server system 136 of the ransomware defense server system 150, as described in greater detail hereinafter.

In some embodiments, the ransomware defense component 133 of the ransomware defense system 130 is configured to respond to ransomware activity based on the kernel telemetry data generated by the kernel monitoring component 120. In some embodiments, the ransomware defense component 133 initiates one or more response procedures when ransomware activity is detected. For example, the ransomware defense component 133 may initiate one or more response procedures in response to determining that a particular process executed under the control of the ransomware agent. The response procedures may include actions to mitigate and/or prevent the spread of any ransomware, such as terminating the process, taking the computer on which the process executed offline, otherwise isolating the process and/or the computer, restricting permissions, blocking access to sensitive data, blocking network access, or other responsive actions. In some embodiments, the ransomware defense component 133 may implement advanced countermeasures such as dynamic resource throttling, deceptive file systems, or redirecting ransomware activity to honeypot environments for further analysis. These procedures aim to minimize damage, ensure continuity of operations, and enhance overall system resilience against ransomware threats.

In some embodiments, the one or more response procedures include preventing execution of the system call. For example, the ransomware defense system 130 may be configured to prevent execution of a system call associated with the particular process when a hallmark is detected. For example, the kernel monitoring component 120 may intercept a system call and generate kernel telemetry data for the system call when the system call is invoked. The kernel monitoring component 120 may enforce conditional execution by requiring clearance from the ransomware detection component 132 before allowing the system call to execute normally without modification. The ransomware detection component 132 may allow execution of a system call to proceed when no hallmark is detected in the corresponding kernel telemetry data. When the ransomware detection component 132 detects a hallmark, the ransomware defense system 130 may deny the system call, modify the system call, simulate execution of the system call by fabricating a return value without actually executing the system call, hold the system call for further analysis, or otherwise alter execution of the system call. In some embodiments, at least a portion of the ransomware defense component 133 is integrated with the kernel monitoring component 120 in kernel space to handle system calls associated with a ransomware agent.

In some embodiments, the one or more response procedures include initiating a remediation process to address ransomware on the computer system. For example, the ransomware defense component 133 may be configured to automatically perform one or more remediation processes, such as isolating one or more applications, systems, and/or resources. As an alternative and/or addition, the ransomware defense component 133 may be configured to automatically determine and/or report on potentially affected applications, systems, and/or resources. The ransomware defense component 133 may use kernel telemetry data, such as kernel telemetry data stored in the event database 140 to perform one or more automatic remediation processes.

In some embodiments, the one or more response procedures include notifying one or more systems and/or response teams for handling cybersecurity breaches. For example, the ransomware defense component 133 may be configured to notify an incident response team. The incident response team may evaluate the scope of the ransomware attack, identify affected systems and resources, contain the ransomware threat, and/or initiate recovery processes such as restoring encrypted files from backups, rolling back the system state to a pre-infection snapshot, or applying security patches to remediate exploited vulnerabilities.

In some embodiments, the ransomware defense component 133 is configured to operate based on response configuration settings provided by the ransomware defense server system 150. For example, the ransomware defense system 130 may obtain response configuration settings from a configuration server system 136 of the ransomware defense server system 150, as described in greater detail hereinafter.

### Example Implementation

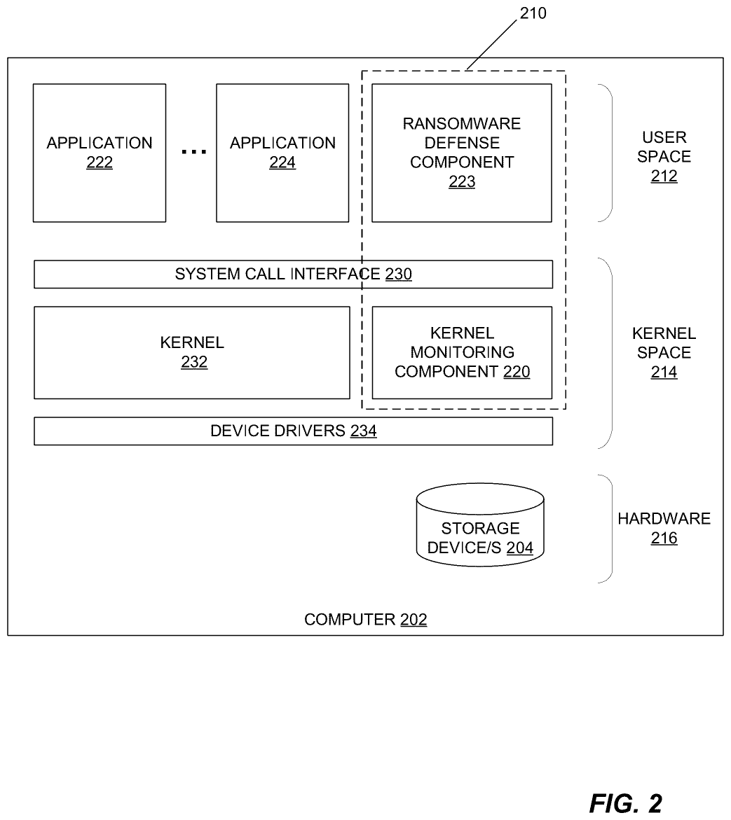

FIG. 2 illustrates a protected computer in an example embodiment. The computer 202 may be a hardware computer. As an alternative and/or addition, the computer 202 may be a virtual computer. For example, the computer 202 may be a virtual machine configured to emulate a hardware computer. One or more techniques described herein may be adapted to a hypervisor and/or other virtual machine architecture components without departing from the spirit or the scope of the disclosure.

The computer 202 includes user space 212 and kernel space 214. The user space 212 is a portion of the memory of the computer 202 where user-mode applications 222-224 run. That is, the processes corresponding to the user-level applications 222-224 execute within user space 212. The user space 212 typically contains the code, data, and stack of the applications 222-224.

The kernel space 214 is a dedicated portion of the memory of the computer 202 that is reserved for the operating system's kernel and other components. The kernel space 214 typically contains core components of the operating system, such as the kernel 232, device drivers 234, and critical system data structures. Access to the kernel space is restricted from user space 212. Kernel-level operations may execute in a privileged mode and may access system functions and resources directly. For example, kernel-level processes may have unrestricted file system and memory access, handle system calls, manage interrupts, execute privileged instructions, override user space permissions, and use other kernel-mode privileges.

Applications 222-224 executing in user space 212 utilize the system call interface 230 to access lower-level components. The system call interface 230 is a programming interface that enables user-level applications 222-224 to request services and functionality from the operating system's kernel 232. For example, the applications 222-224 can initiate system calls to access resources within the kernel space 214, such as but not limited to device drivers 234, critical kernel data structures, kernel code, memory management services, file systems, networking functionalities, and process and thread management features. The device drivers 234 and/or other components of the kernel space 214 facilitate interactions between user space 212 components and the hardware 216 of the computer 202. The hardware 216 and/or other hardware-level resources may be hardware and/or virtual resources.

The computer 202 is protected by a ransomware defense system 210. In some embodiments, the ransomware defense system 210 includes a kernel monitoring component 220 that executes in kernel space 214. Processes in kernel space 214, including one or more processes of the kernel monitoring component 220, have privileged access to the memory of other processes within the kernel space 214. The kernel monitoring component 220 may be implemented as a kernel-level extension, such as but not limited to a driver, a kernel module, and/or a kernel filter. In some embodiments, the kernel monitoring component 220 is implemented as an I/O intercepting module, such as but not limited to a minifilter driver compatible with the Windows file system or an extended Berkeley packet filter (eBPF) logic.

The kernel monitoring component 220 may be configured to monitor one or more processes executing on the computer 202, such as by collecting kernel telemetry data describing one or more system calls initiated by one or more processes executing in user space 212 and/or kernel space 214. The kernel monitoring component 220 may be configured to collect kernel telemetry data on all system calls. As an alternative and/or addition, the kernel monitoring component 220 may be configured to collect kernel telemetry data on specific system calls and/or specific processes. As an alternative and/or addition, the kernel monitoring component 220 may be configured to filter data collection. In some embodiments, the collection of kernel telemetry data may be based on telemetry configuration settings, including telemetry configuration settings obtained from a ransomware defense server system (e.g., ransomware defense server system 150).

In some embodiments, the ransomware defense system 210 includes one or more application components that execute in user space 212. The ransomware defense component 223 and/or other application component/s may implement features of the ransomware defense system 210 that do not require kernel privileges. For example, the application component/s may be configured to receive, filter, transform, aggregate, format, or otherwise handle kernel telemetry data collected by the kernel monitoring component 220. In some examples, the kernel monitoring component 220 and/or the application component/s may implement data pipeline functionality for handling kernel telemetry data. In some embodiments, the application component/s of the ransomware defense system 210 include a ransomware defense component 223 configured to detect ransomware activity based on the kernel telemetry data and/or respond to detected ransomware activity.

In some embodiments, the application component/s of the ransomware defense system 210 are configured to communicate with a ransomware defense server system (e.g., ransomware defense server system 150). For example, the application component/s may transmit kernel telemetry data to the ransomware defense system, periodically update the ransomware defense server system on its operational status, poll the ransomware defense server system for configuration setting updates (e.g., telemetry configuration data, detection configuration data, response configuration data, and/or other configuration data), or otherwise communicate with the ransomware defense server system.

While this example embodiment depicts a division of ransomware defense system 210 operations between the application component/s and the kernel monitoring component 220, this division is not required. Furthermore, the specific division of operations described between the application component/s and the kernel monitoring component 220 may differ from the described division.

### Ransomware Defense Server System

Returning to FIG. 1, in some embodiments, the ransomware defense server system 150 is configured to support the operation of the ransomware defense system 130 at the enterprise computer system 102. The ransomware defense server system 150 may support one or multiple instances of the ransomware defense system 130 at one or multiple enterprise computer systems 102.

In some embodiments, the ransomware defense server system 150 provides configuration settings for one or more instances of the ransomware defense system 130. For example, the ransomware defense server system 150 may include a configuration server system 136 configured to provide telemetry configuration settings, detection configuration settings, response configuration settings, and/or other configuration settings for one or more components of the ransomware defense system 130. The telemetry configuration settings, detection configuration settings, response configuration settings, and/or other configuration settings provided to one instance of a ransomware defense system 130 may be the same or different from the configuration settings provided to another instance. In some embodiments, an instance of the ransomware defense system 130 is configured to poll the ransomware defense server system 150 for configuration setting updates (e.g., telemetry configuration data, detection configuration data, response configuration data, and/or other configuration data). As an alternative and/or addition, an instance of the ransomware defense system 130 may be configured to provide the ransomware defense server system 150 status information regarding the defense of a corresponding enterprise computer system 102.

The ransomware defense server system 150 may determine configuration settings based on analyzing kernel telemetry data corresponding to ransomware, including new ransomware variants. For example, the ransomware defense server system 150 may include a ransomware behavior analysis system 138. The ransomware behavior analysis system 138 is configured to analyze the execution of one or more ransomware variants and generate one or more hallmarks comprising one or more patterns of kernel-level behavior consistent with specific ransomware variants.

In some embodiments, the ransomware defense system 130 of an enterprise computer system 102 may provide the ransomware defense server system 150 with kernel telemetry data for analysis at the ransomware defense server system 150. The ransomware defense server system 150 may analyze the kernel telemetry data to detect ransomware, evaluate patterns over time, detect new threats, and/or perform other related functions. In some embodiments, the ransomware defense server system 150 analyzes kernel telemetry data collected from multiple In some embodiments, the configuration server system 136 monitors the lifecycle of individual instances of the kernel monitoring component 120. For example, an instance of the kernel monitoring component 120 may submit a periodic request to the configuration server system 136 at a regular interval. The request may include an operating status of the instance of the kernel monitoring component 120. As an alternative and/or addition, the configuration server system 136 may infer that the operating status of the instance is compromised or otherwise atypical based on the absence of the periodic request.

In some embodiments, the configuration server system 136 responds to the request with new configuration setting data to change the configuration settings of the instance of the kernel monitoring component 120. For example, the configuration server system 136 may provide a configuration identifier corresponding to a particular configuration file in response to the request from the instance of the kernel monitoring component 120. When the instance of the kernel monitoring component 120 receives the configuration identifier, the instance may use the configuration identifier to obtain the corresponding configuration file from the configuration server system 136 and/or the ransomware defense system 130. By employing a polling mechanism, the kernel monitoring component 120 may avoid exposing an application programming interface (API) for controlling the operation of the kernel monitoring component 120.

### Ransomware Testing System

In some embodiments, the ransomware defense server system 150 includes a ransomware testing system 110. The ransomware testing system 110 is configured to manage the deployment of ransomware in an isolated test environment. The ransomware testing system 110 may be configured to generate an enterprise replica in the isolated test environment and deploy a ransomware variant in the isolated test environment to determine the effect of the ransomware variant on the enterprise replica. As an alternative and/or addition, the ransomware testing system 110 may generate the enterprise replica with a ransomware defense system (e.g., ransomware defense system 130) to determine the effectiveness of the ransomware defense system. The ransomware testing system 110 and the enterprise replica are described in greater detail hereinafter.

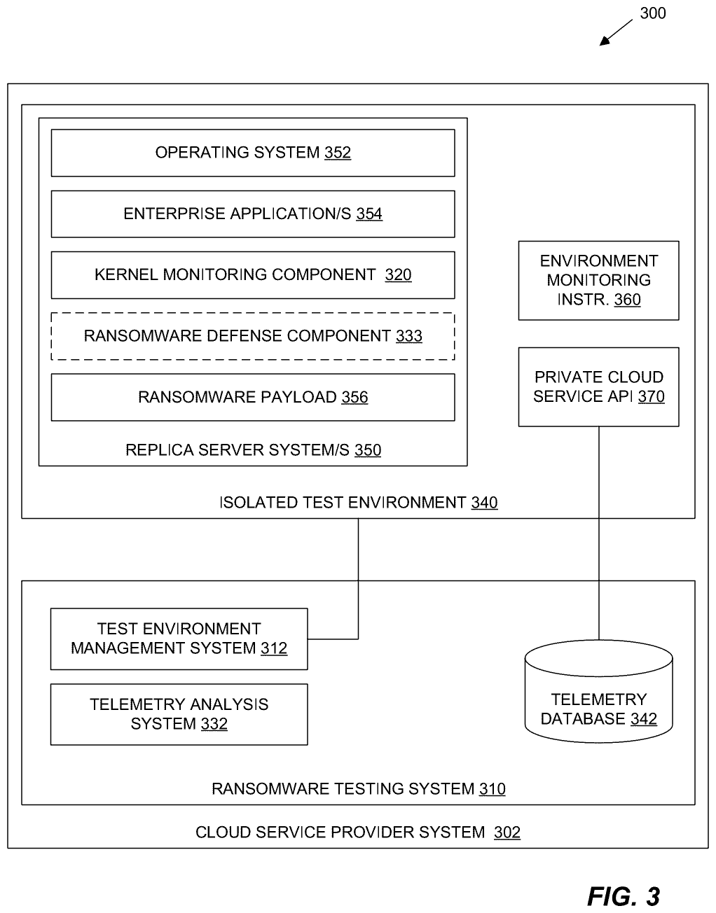

FIG. 3 illustrates a computer system that includes a ransomware testing system and an isolated test environment in an example embodiment. The computer system 300 includes a ransomware testing system 310 and an isolated test environment 340. In some embodiments, the isolated test environment 340 is deployed in a cloud environment hosted by the same cloud service provider hosting the ransomware testing system 310.

In some embodiments, the ransomware testing system 310 includes a test environment management system 312. The test environment management system 312 may be configured to control the deployment and lifecycle of the isolated test environment 340. In some embodiments, the test environment management system 312 is configured to generate an enterprise replica in the isolated test environment 340. The enterprise replica may include one or more replica server systems 350. Each replica server system 350 may correspond to a hardware computer and/or virtual computer of an enterprise computer system (e.g., enterprise computer system 102).

In some embodiments, the test environment management system 312 is configured to assign one or more enterprise applications 354 to the one or more replica server systems 350 to be provisioned in the isolated test environment 340. For example, the deployed enterprise application/s 354 may include a set of one or more critical enterprise applications and/or required applications on which the critical enterprise application/s depend. In some embodiments, the test environment management system 312 provides a user interface to select or otherwise specify one or more critical applications. In some embodiments, the ransomware testing system 310 evaluates one or more application dependencies involving a selected application and identifies one or more additional applications to also run on the replica server system/s 350. The test environment management system 312 may be configured to deploy a set of one or more critical applications and resource dependencies, such as any required applications, required data sources, required services, and/or other resource dependencies that are required by one or more critical applications. The dependencies may be detected based on kernel telemetry data, as described in greater detail hereinafter.

In some embodiments, the test environment management system 312 provides a user interface to select or otherwise specify one or more server parameters for the replica server system/s 350. For example, the server parameters may include one or more selected operating systems 352 for the replica server system/s 350. As an alternative and/or addition, the server parameters may include network configurations, hardware specifications, middleware components, application frameworks, security settings, threat detection tools, monitoring tools, storage configurations, registry settings, configuration data, backup and recovery settings, virtualization parameters, and/or other server parameters. The test environment management system 312 may be configured to provision the replica server system/s 350 in the isolated test environment 340 based on the specified server parameters. The server parameters may be uniform across the replica server system/s 350. As an alternative and/or addition, one or more the server parameters may differ across the replica server system/s 350. One or more server parameters may be selected to match the configuration of one or more enterprise server systems. As an alternative and/or addition, one or more server parameters may be selected to explore the performance of potential server system configurations in response to ransomware.

In some embodiments, the test environment management system 312 provides a user interface to select or otherwise specify one or more application parameters for the enterprise application/s 354, including critical application/s and/or required application/s. For example, the application parameters may include one or more settings, installation options, configurations, or other parameters of one or more enterprise applications 354. The test environment management system 312 may be configured to deploy the enterprise applications 354 on the replica server system/s 350 in the isolated test environment 340 based on the specified server parameters. One or more application parameters may be selected to match the configuration of one or more applications deployed and/or planned for deployment on one or more enterprise server systems. As an alternative and/or addition, one or more application parameters may be selected to explore the performance of potential application configurations in response to ransomware.

In some embodiments, the test environment management system 312 generates the enterprise replica in the isolated test environment 340 by provisioning the replica server system/s 350 in the isolated test environment 340 with the selected operating system/s 352, any other selected server parameters, and/or any application parameters. The provisioned replica server system/s 350 execute the enterprise application/s 354 in the isolated test environment 340.

In some embodiments, the test environment management system 312 deploys a kernel monitoring component 320 on the replica server system/s 350 in the isolated test environment 340. The kernel monitoring component 320 is configured to collect kernel-level data describing one or more system calls initiated by processes executing on the replica server system/s 350 and generate kernel telemetry data describing kernel-level behavior associated with the one or more system calls. The kernel monitoring component 320 may include one or more features described herein with respect to the kernel monitoring component of a ransomware defense system (e.g., kernel monitoring component 120 of ransomware defense system 130).

In some embodiments, the test environment management system 312 deploys a ransomware defense component 333 on at least one of the replica server system/s 350 in the isolated test environment 340. The ransomware defense component 333 is configured to analyze the kernel telemetry data generated by the kernel monitoring component 320, determine that a particular process executed under control of a ransomware agent based on analyzing the kernel telemetry data, and initiate one or more response measures in response to determining that the particular process executed under control of the ransomware agent. The ransomware defense component 333 may include one or more features described herein with respect to the ransomware defense component of a ransomware defense system (e.g., ransomware defense component 133 of ransomware defense system 130).

For example, a replica server system 350 may be deployed with a kernel monitoring component 320 to collect kernel telemetry data without a ransomware defense component 333. As an alternative and/or addition, a replica server system 350 may be deployed with both a kernel monitoring component 320 and a ransomware defense component 333. While the kernel monitoring component 320 allows kernel telemetry data to be collected on a specific computer, not every computer in an enterprise replica is required to have a kernel monitoring component 320.

In some embodiments the test environment management system 312 is configured to deploy a selected ransomware variant in the isolated test environment 340. For example, the test environment management system 312 may deliver or otherwise include a ransomware payload 356 on one or more replica server systems 350. The ransomware payload 356 may include ransomware code that is configured to execute on one or more replica server systems 350. In some embodiments, the test environment management system 312 provides a user interface to select or otherwise specify a ransomware variant to deploy in the isolated test environment 340.

The kernel monitoring component 320 generates kernel telemetry data when the replica server system/s 350 run. In some embodiments, the test environment management system 312 is configured to trigger detonation of the ransomware variant on the replica server system/s 350. The test environment management system 312 may be configured to extract kernel telemetry data from the isolated test environment 340. For example, the test environment management system 312 may use a private cloud service API 370 to transfer the kernel telemetry data to a telemetry database 342 without exposing the infected isolated test environment 340 to the Internet. After the ransomware detonation is complete and the telemetry data is exported, the test environment management system 312 may terminate the infected isolated test environment 340.

In some embodiments, the ransomware testing system 310 includes a telemetry analysis system 332. The telemetry analysis system 332 is configured to analyze the kernel telemetry data and determine the effect of the selected ransomware variant on the enterprise replica. For example, the telemetry analysis system 332 may identify: processes that were started, stopped, or otherwise affected; system services that were started, stopped, or otherwise affected; threat detection tools that were started, stopped, or otherwise affected; other applications that were started, stopped, or otherwise affected; processes that were under the control of ransomware; registry values and/or other system configuration data that were modified; files and/or directories that were accessed, encrypted, otherwise modified, exfiltrated, and/or otherwise affected; networking requests, connections, and/or sessions associated with ransomware activity; privileges that were escalated and/or otherwise modified; user accounts that were compromised; database queries associated with ransomware activity; and/or other effects associated with ransomware activity. In some embodiments, the telemetry analysis system 332 identifies one or more processes that executed under the control of ransomware and determines one or more effects of the ransomware based on kernel telemetry data associated with the corresponding processes.

In some embodiments, the ransomware testing system 310 determines one or more effects of ransomware activity based on performing a health check on the replica server system/s 350 after ransomware detonation. The health check may include running a set of automated system tests to determine whether the enterprise application/s 354 are running correctly. For example, the set of automated system tests may include executing one or more SQL queries, web requests, and/or other transactions and determining whether the enterprise application/s 354 return the correct values. As an alternative and/or addition, the set of automated system tests may include verifying that a list of processes, services, threat detection tools, and/or other applications are running correctly. As an alternative and/or addition, the set of automated system tests may include verifying that specified registry values and/or other system configuration data are correct.

In some embodiments, the ransomware testing system 310 is configured to test the enterprise replica against a plurality of ransomware variants in additional isolated test environments 340. In some embodiments, the ransomware testing system 310 tests a first version of the enterprise replica without the ransomware defense component 330 and one or more additional versions of the enterprise replica with the ransomware defense component 330. The ransomware testing system 310 may compare the effects of one or more ransomware variants on the unprotected enterprise replica and the protected enterprise replica. For example, the telemetry analysis system 332 may compare kernel telemetry data collected from multiple iterations of ransomware execution. The telemetry analysis system 332 may identify a set of differences that are attributable to the ransomware defense component 330.

In some embodiments, the ransomware testing system 310 simulates one or more ransomware attacks on variations of the enterprise replica where the selected operating system 352 and/or other server parameters are modified across the variations. As an alternative and/or addition, the ransomware testing system 310 may simulate one or more ransomware attacks on variations of the enterprise replica where application parameters are modified across the variations.

In some embodiments, the test environment management system 312 deploys environment monitoring instrumentation 360 in the isolated test environment 340. The environment monitoring instrumentation 360 is configured to collect resource consumption telemetry data corresponding to resource usage by the kernel monitoring component 320 and/or the ransomware defense component 333. The test environment management system 312 may extract the resource consumption telemetry data from the isolated test environment 340 in a manner that does not expose the infected isolated test environment 340 to the Internet, such as via the private cloud service API 370. The telemetry analysis system 332 may determine resource consumption by the kernel monitoring component 320 and/or the ransomware defense component 333 based on the resource consumption telemetry data. As an alternative and/or addition, the telemetry analysis system 303 two may determine the effect of said resource consumption on the performance of the replica server system/s 350.

### Determining Dependencies for an Enterprise Replica

In some embodiments, dependencies of a critical application may be detected based on kernel telemetry data. For example, a ransomware defense server system (e.g., ransomware defense server system 150) may determine one or more resource dependencies of one or more enterprise applications 354, obtaining a set of resources to deploy in the isolated test environment 340 based on the one or more resource dependencies, and deploy the set of resources in the isolated test environment 340. The resources may include middleware, supporting applications, services, other applications, databases, files, directories, storage volumes, APIs, data pipelines, networking resources, libraries, plug-ins, authentication systems, certificates, and/or other resources that may be required for an application to run.

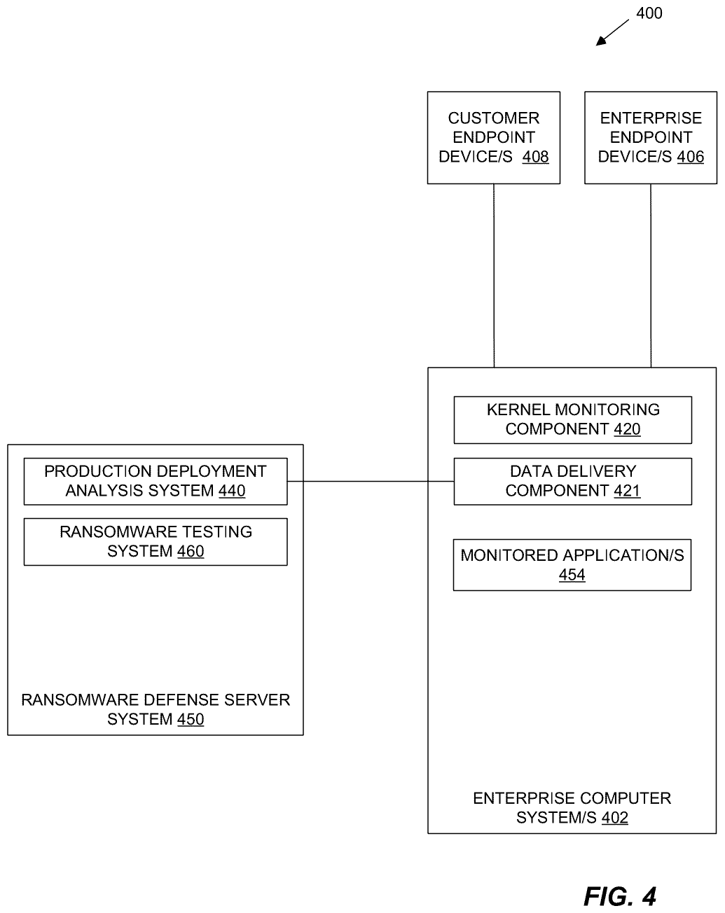

In some embodiments, a ransomware defense server system obtains kernel telemetry data from a production system of an enterprise and analyzes the kernel telemetry data to determine one or more resource dependencies. FIG. 4 illustrates a computer system that includes a production deployment analysis system configured to analyze production kernel telemetry data to configure an enterprise replica in an example embodiment. The computer system 400 includes a ransomware defense server system 450 and one or more enterprise computer systems 402 running in a production system of the enterprise. Customer endpoint device/s 408 and/or enterprise endpoint device/s 406 may access the enterprise computer system/s 402.

The one or more enterprise computer systems 402 and include one or more hardware computers and/or virtual computers on which one or more monitored application/s 454 are deployed. A kernel monitoring component 420 executing on the enterprise computer system/s 402 is configured to generate production kernel telemetry data for system calls initiated by processes executing on the enterprise computer system/s 402. The kernel monitoring component 420 may generate the production kernel telemetry data using any of the techniques described herein. In some embodiments, the kernel monitoring component 420 is deployed on one or more production server systems running the monitored application/s 454. The kernel monitoring component 420 may execute in kernel space of one or more hardware computers and/or virtual computers of the enterprise computer system/s 402.

A data delivery component 421 associated with the kernel monitoring component 420 is configured to transmit the production kernel telemetry data to a production deployment analysis system 440 of the ransomware defense server system 450. The data delivery component 421 may transform, filter, aggregate, format, and/or otherwise process the production kernel telemetry data before transmitting the production kernel telemetry data to the production deployment analysis system 440. The production deployment analysis system 440 is configured to determine resource dependencies of the monitored application/s 454 based on the production kernel telemetry data. The ransomware testing system 460 may use the determined resource dependencies to generate an enterprise replica in an isolated test environment as described herein.

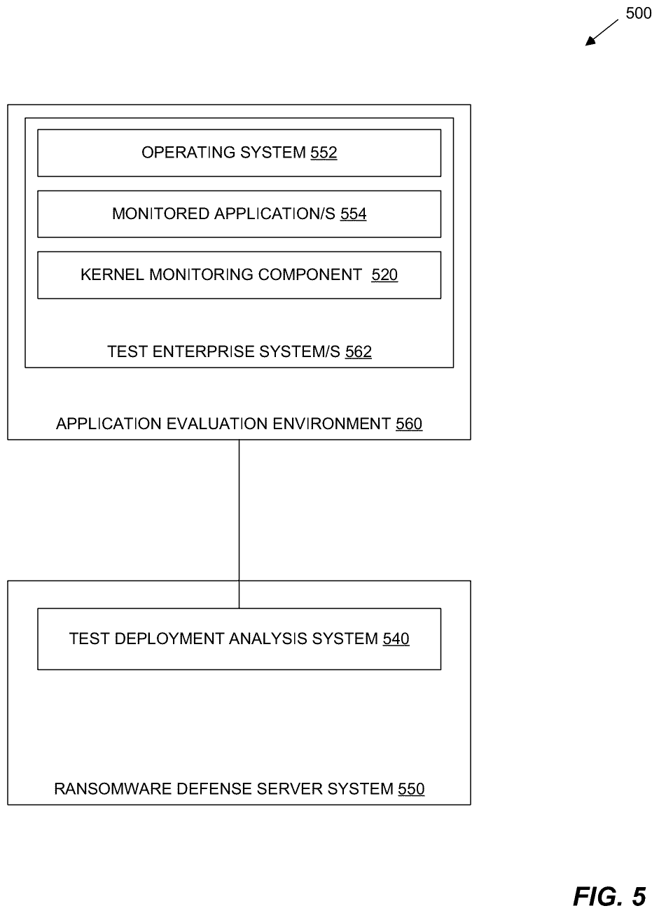

In some embodiments, a ransomware defense server system obtains kernel telemetry data from an application evaluation environment 560 and analyzes the kernel telemetry data to determine one or more resource dependencies. FIG. 5 illustrates a computer system that includes a test deployment analysis system configured to analyze test kernel telemetry data to configure an enterprise replica in an example embodiment. The computer system 500 includes a ransomware defense server system 550 comprising a test deployment analysis system 540. The test deployment analysis system 540 is configured to analyze test kernel telemetry data obtained from one or more test enterprise systems 562 deployed in an application evaluation environment 560.

The test analysis system 540 may be configured to control the deployment and lifecycle of one or more test enterprise systems 562 in an application evaluation environment 560. The test enterprise systems 562 may be based on one or more snapshots, virtual machine images, or other representations of an enterprise server system. In some embodiments, the test deployment analysis system 540 is implemented as a mode of a test environment management system (e.g., test environment management system 312) with the capability to test ransomware in an isolated test environment.

In some embodiments, the test deployment analysis system 540 is configured to deploy one or more test enterprise systems 562 running one or more monitored applications 554 in the application evaluation environment 560 and deploy a kernel monitoring component 520 on the test enterprise system/s 562. The kernel monitoring component 520 is configured to generate test kernel telemetry data for system calls initiated by processes executing on the test enterprise system/s 562. where determining the one or more resource dependencies is based on the test kernel telemetry data.

The test deployment analysis system 540 may obtain the test kernel telemetry data using any technique described herein. The test deployment analysis system 540 is configured to determine resource dependencies of the monitored application/s 554 based on the test kernel telemetry data. A ransomware testing system (e.g., ransomware testing system 310) may use the determined resource dependencies to generate an enterprise replica in an isolated test environment as described herein.

In some embodiments, a ransomware defense server system obtains kernel telemetry data from an application evaluation environment 560 and analyzes the kernel telemetry data to determine one or more resource dependencies. FIG. 5 illustrates a computer system that includes a test deployment analysis system configured to analyze test kernel telemetry data to configure an enterprise replica in an example embodiment. The computer system 500 includes a ransomware defense server system 550 comprising a test deployment analysis system 540. The test deployment analysis system 540 is configured to analyze test kernel telemetry data obtained from one or more test enterprise systems 562 deployed in an application evaluation environment 560.

### Example Processes

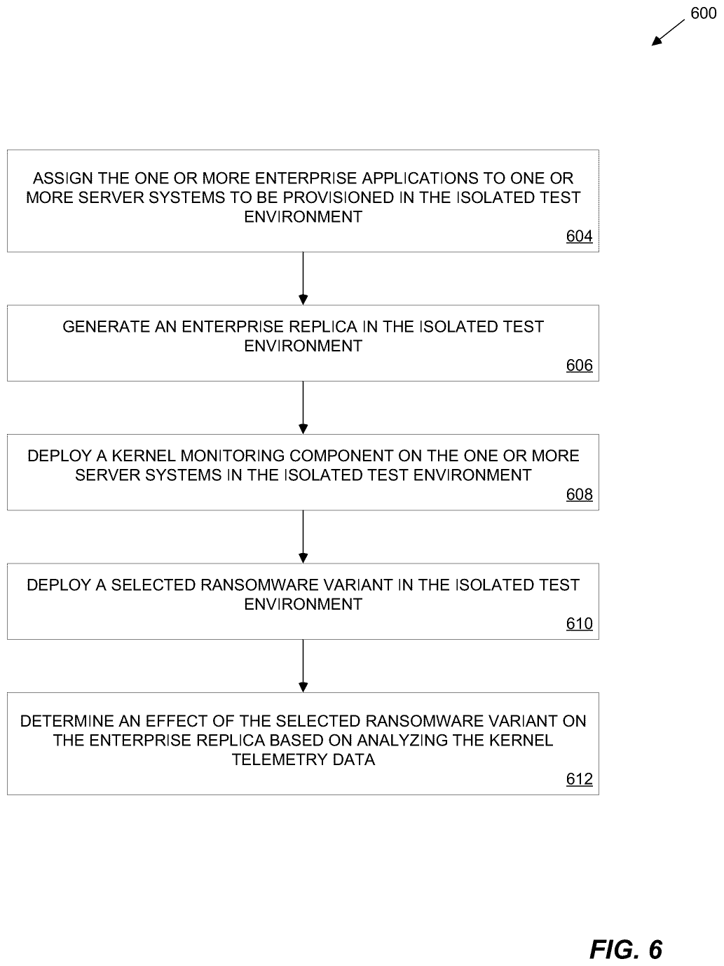

FIG. 6 is a flow diagram of a process for analyzing the effect of ransomware on an enterprise replica in an isolated test environment in an example embodiment. Process 600 may be performed by one or more computing devices and/or processes thereof. For example, one or more blocks of process 600 may be performed by computer system 700. In some embodiments, one or more blocks of process 600 are performed by a ransomware testing system executing on a hardware or virtual computer, such as the ransomware testing system 310 of FIG. 3. Process 600 will be described with respect to the ransomware testing system 310 of FIG. 3, but its performance is not limited thereto.

At block 604, the ransomware testing system 310 assigns one or more enterprise applications to one or more server systems to be provisioned in an isolated test environment.

At block 606, the ransomware testing system 310 generates an enterprise replica in the isolated test environment by provisioning the one or more server systems and deploying the one or more enterprise applications on the one or more server systems in the isolated test environment.

At block 608, the ransomware testing system 310 deploys a kernel monitoring component on the one or more server systems in the isolated test environment, the kernel monitoring component configured to generate kernel telemetry data for a plurality of system calls initiated by processes executing on the one or more server systems.

At block 610, the ransomware testing system 310 deploys a selected ransomware variant in the isolated test environment.

At block 612, the ransomware testing system 612 determines an effect of the selected ransomware variant on the enterprise replica based on analyzing the kernel telemetry data.

### Implementation Mechanisms—Hardware Overview

According to one embodiment, the techniques described herein are implemented by one or more special-purpose computing devices. The special-purpose computing devices may be hard-wired to perform one or more techniques described herein, including combinations thereof. Alternatively and/or in addition, the one or more special-purpose computing devices may include digital electronic devices such as one or more application-specific integrated circuits (ASICs) or field-programmable gate arrays (FPGAs) that are persistently programmed to perform the techniques. Alternatively and/or in addition, the one or more special-purpose computing devices may include one or more general-purpose processors programmed to perform the techniques described herein pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, and/or any other device that incorporates hard-wired or program logic to implement the techniques.

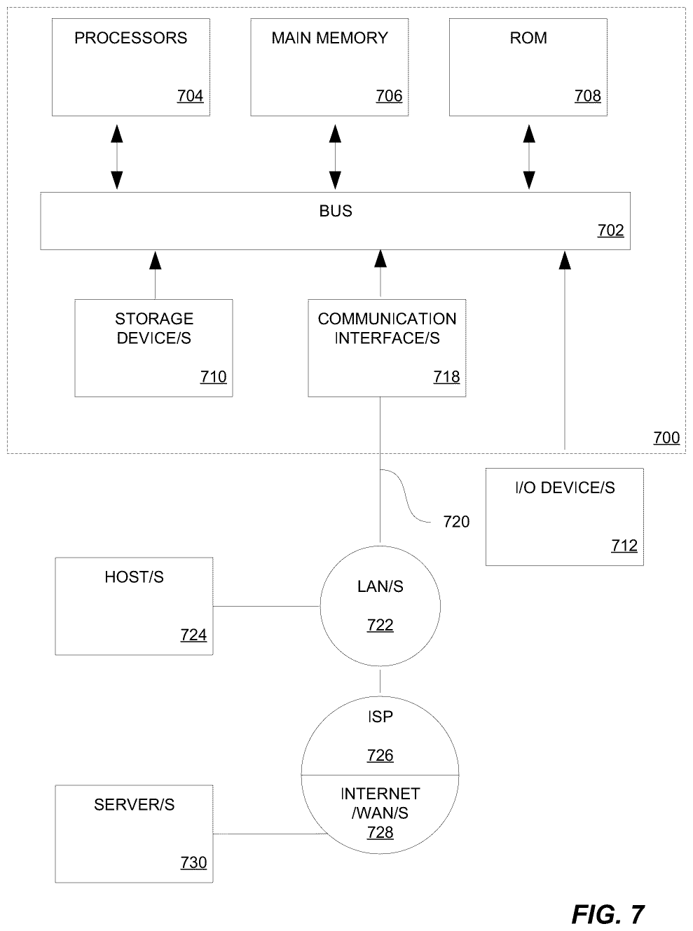

FIG. 7 is a block diagram that illustrates a computer system 700 upon which one or more embodiments described herein may be implemented. The computer system 700 includes a bus 702 or another communication mechanism for communicating information, and one or more processors 704 coupled with bus 702 for processing information, such as computer instructions and data. The hardware processor/s 704 may include one or more general-purpose microprocessors, graphical processing units (GPUs), coprocessors, central processing units (CPUs), and/or other hardware processing units. As an alternative or addition, one or more computer systems 700 may be configured to provide a cloud computing environment, virtual machine, and/or other software-based emulation of a physical computing environment upon which one or more embodiments described herein may be implemented.

The computer system 700 also includes one or more units of main memory 706 coupled to the bus 702, such as random-access memory (RAM) or other dynamic storage, for storing information and instructions to be executed by the processor/s 704. Main memory 706 may also be used for storing temporary variables or other intermediate information during execution of instructions to be executed by the processor/s 704. Such instructions, when stored in non-transitory storage media accessible to the processor/s 704, turn the computer system 700 into a special-purpose machine that is customized to perform the operations specified in the instructions. In some embodiments, main memory 706 may include dynamic random-access memory (DRAM) (including but not limited to double data rate synchronous dynamic random-access memory (DDR SDRAM), thyristor random-access memory (T-RAM), zero-capacitor (Z-RAM™)) and/or non-volatile random-access memory (NVRAM).

The computer system 700 may further include one or more units of read-only memory (ROM) 708 or other static storage coupled to the bus 702 for storing information and instructions for the processor/s 704 that are either always static or static in normal operation but reprogrammable. For example, the ROM 708 may store firmware for the computer system 700. The ROM 708 may include mask ROM (MROM) or other hard-wired ROM storing purely static information, programmable read-only memory (PROM), erasable programmable read-only memory (EPROM), electrically-erasable programmable read-only memory (EEPROM), another hardware memory chip or cartridge, or any other read-only memory unit.

One or more storage devices 710, such as a magnetic disk or optical disk, is provided and coupled to the bus 702 for storing information and/or instructions. The storage device/s 710 may include non-volatile storage media such as, for example, read-only memory, optical disks (such as but not limited to compact discs (CDs), digital video discs (DVDs), Blu-ray discs (BDs)), magnetic disks, other magnetic media such as floppy disks and magnetic tape, solid-state drives, flash memory, optical disks, one or more forms of non-volatile random-access memory (NVRAM), and/or other non-volatile storage media.

The computer system 700 may be coupled via the bus 702 to one or more input/output (I/O) devices 712. For example, the I/O device/s 712 may include one or more displays for displaying information to a computer user, such as a cathode ray tube (CRT) display, a Liquid Crystal Display (LCD) display, a Light-Emitting Diode (LED) display, a projector, and/or any other type of display.

The I/O device/s 712 may also include one or more input devices, such as an alphanumeric keyboard and/or any other keypad device. The one or more input devices may also include one or more cursor control devices, such as a mouse, a trackball, a touch input device, or cursor direction keys for communicating direction information and command selections to the processor 704 and for controlling cursor movement on another I/O device (e.g. a display). A cursor control device typically has at degrees of freedom in two or more axes, (e.g. a first axis x, a second axis y, and optionally one or more additional axes z), that allows the device to specify positions in a plane. In some embodiments, the one or more I/O device/s 712 may include a device with combined I/O functionality, such as a touch-enabled display.

Other I/O device/s 712 may include a fingerprint reader, a scanner, an infrared (IR) device, an imaging device such as a camera or video recording device, a microphone, a speaker, an ambient light sensor, a pressure sensor, an accelerometer, a gyroscope, a magnetometer, another motion sensor, or any other device that can communicate signals, commands, and/or other information with the processor/s 704 over the bus 702.

The computer system 700 may implement the techniques described herein using customized hard-wired logic, one or more ASICs or FPGAs, firmware, and/or program logic that causes computer system 700 to be a special-purpose machine. According to one embodiment, the techniques herein are performed by the computer system 700 in response to the processor/s 704 executing one or more sequences of one or more instructions contained in main memory 706. Such instructions may be read into main memory 706 from another storage medium, such as the one or more storage device/s 710. Execution of the sequences of instructions contained in main memory 706 causes the processor/s 704 to perform the process steps described herein. In alternative embodiments, hard-wired circuitry may be used in place of or in combination with software instructions.

The computer system 700 also includes one or more communication interfaces 718 coupled to the bus 702. The communication interface/s 718 provide two-way data communication over one or more physical or wireless network links 720 that are connected to a local network 722 and/or a wide area network (WAN), such as the Internet. For example, the communication interface/s 718 may include an integrated services digital network (ISDN) card, cable modem, satellite modem, or a modem to provide a data communication connection to a corresponding type of telephone line. Alternatively and/or in addition, the communication interface/s 718 may include one or more of: a local area network (LAN) device that provides a data communication connection to a compatible local network 722; a wireless local area network (WLAN) device that sends and receives wireless signals (such as electrical signals, electromagnetic signals, optical signals or other wireless signals representing various types of information) to a compatible LAN; a wireless wide area network (WWAN) device that sends and receives such signals over a cellular network; and other networking devices that establish a communication channel between the computer system 700 and one or more LANs 722 and/or WANs.

The network link/s 720 typically provides data communication through one or more networks to other data devices. For example, the network link/s 720 may provide a connection through one or more local area networks 722 (LANs) to one or more host computers 724 or to data equipment operated by an Internet Service Provider (ISP) 726. The ISP 726 provides connectivity to one or more wide area networks 728, such as the Internet. The LAN/s 722 and WAN/s 728 use electrical, electromagnetic, or optical signals that carry digital data streams. The signals through the various networks and the signals on the network link/s 720 and through the communication interface/s 718 are example forms of transmission media or transitory media.

The term “storage media” as used herein refers to any non-transitory media that stores data and/or instructions that cause a machine to operate in a specific fashion. Such storage media may include volatile and/or non-volatile media. Storage media is distinct from but may be used in conjunction with transmission media. Transmission media participates in transferring information between storage media. For example, transmission media includes coaxial cables, copper wire, and fiber optics, including traces and/or other physical electrically conductive components that comprise the bus 702. Transmission media can also take the form of acoustic or light waves, such as those generated during radio-wave and infrared data communications.

Various forms of media may be involved in carrying one or more sequences of one or more instructions to the processor 704 for execution. For example, the instructions may initially be carried on a magnetic disk or solid-state drive of a remote computer. The remote computer can load the instructions into its main memory 706 and send the instructions over a telecommunications line using a modem. A modem local to the computer system 700 can receive the data on the telephone line and use an infrared transmitter to convert the data to an infrared signal. An infra-red detector can receive the data carried in the infra-red signal and appropriate circuitry can place the data on the bus 702. The bus 702 carries the data to main memory 706, from which the processor 704 retrieves and executes the instructions. The instructions received by main memory 706 may optionally be stored on the storage device 710 either before or after execution by the processor 704.

The computer system 700 can send messages and receive data, including program code, through the network(s), the network link 720, and the communication interface/s 718. In the Internet example, one or more servers 730 may transmit signals corresponding to data or instructions requested for an application program executed by the computer system 700 through the Internet 728, ISP 726, local network 722 and a communication interface 718. The received signals may include instructions and/or information for execution and/or processing by the processor/s 704. The processor/s 704 may execute and/or process the instructions and/or information upon receiving the signals by accessing main memory 706, or at a later time by storing them and then accessing them from the storage device/s 710.

### Other Aspects of Disclosure

Although the concepts herein have been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

What is claimed is:

1. A method comprising:
assigning one or more enterprise applications to one or more server systems to be provisioned in an isolated test environment;
generating an enterprise replica in the isolated test environment by provisioning the one or more server systems and deploying the one or more enterprise applications on the one or more server systems in the isolated test environment;
deploying a kernel monitoring component on the one or more server systems in the isolated test environment, the kernel monitoring component configured to generate kernel telemetry data for a plurality of system calls initiated by processes executing on the one or more server systems;
deploying a selected ransomware variant in the isolated test environment; and
determining an effect of the selected ransomware variant on the enterprise replica based on analyzing the kernel telemetry data;
wherein the method is performed by one or more processors.

2. The method of claim 1, wherein the kernel telemetry data associates, for each system call of the plurality of system calls, a process invoking the system call, an operation type of the system call, and a target of the system call.

3. The method of claim 1, further comprising:
selecting one or more application parameters for the one or more enterprise applications;
wherein generating the enterprise replica is based on the one or more application parameters.

4. The method of claim 1, further comprising:
selecting one or more server parameters for the one or more server systems;
wherein the one or more server systems are provisioned based on the one or more server parameters.

5. The method of claim 1, further comprising:
generating a second enterprise replica in a second isolated test environment by provisioning the one or more server systems and deploying the one or more enterprise applications with at least one configuration difference from the enterprise replica;
deploying the kernel monitoring component and the selected ransomware variant in the second isolated test environment, the kernel monitoring component configured to generate second kernel telemetry data for a second plurality of system calls initiated by processes executing on the one or more server systems in the second isolated test environment;
determining a second effect of the selected ransomware variant on the enterprise replica in the second isolated test environment based on analyzing the second kernel telemetry data; and
identifying a set of differences between the effect and the second effect that are attributable to the at least one configuration difference.

6. The method of claim 5, wherein the at least one configuration difference comprises deploying a ransomware defense component on at least one of the one or more server systems in the second isolated test environment.

7. The method of claim 5, wherein the at least one configuration difference includes at least one of:
one or more different application parameters for the one or more enterprise applications; and
one or more different system parameters for the one or more server systems.

8. The method of claim 1, further comprising:
deploying a ransomware defense component on at least one of the one or more server systems in the isolated test environment, the ransomware defense component configured to:
analyze the kernel telemetry data;
based on analyzing the kernel telemetry data, determine that a particular process executed under control of a ransomware agent; and
in response to determining that the particular process executed under control of the ransomware agent, initiate one or more response measures.

9. The method of claim 1, further comprising:
determining one or more resource dependencies of the one or more enterprise applications;
obtaining a set of resources to deploy in the isolated test environment based on the one or more resource dependencies; and
deploying the set of resources in the isolated test environment.

10. The method of claim 9 wherein determining the one or more resource dependencies comprises:
deploying the kernel monitoring component on one or more production server systems running the one or more applications, wherein the kernel monitoring component generates production kernel telemetry data for a third plurality of system calls initiated by processes executing on the one or more production server systems;
wherein determining the one or more resource dependencies is based on the production kernel telemetry data.

11. The method of claim 9, wherein determining the one or more resource dependencies comprises:
deploying one or more test server systems running the one or more applications in an application evaluation environment; and
deploying the kernel monitoring component on the one or more test server systems, wherein the kernel monitoring component generates test kernel telemetry data for a fourth plurality of system calls initiated by processes executing on the one or more test server systems;
wherein determining the one or more resource dependencies is based on the test kernel telemetry data.

12. The method of claim 1, further comprising:
deploying environment monitoring instrumentation in the isolated test environment, the environment monitoring instrumentation configured to collect resource consumption telemetry data corresponding to resource usage by the kernel monitoring component; and
determining an effect of the kernel monitoring component on the enterprise replica based on the resource consumption telemetry data.

13. A computer system comprising:
one or more processors;
at least one memory storing one or more instructions which, when executed by the one or more processors, cause the one or more processors to:
select one or more enterprise applications to run in an isolated test environment;
assign one or more enterprise applications to one or more server systems to be provisioned in an isolated test environment;
generate an enterprise replica in the isolated test environment by provisioning the one or more server systems and deploying the one or more enterprise applications on the one or more server systems in the isolated test environment;
deploy a kernel monitoring component on the one or more server systems in the isolated test environment, the kernel monitoring component configured to generate kernel telemetry data for a plurality of system calls initiated by processes executing on the one or more server systems;
deploy a selected ransomware variant in the isolated test environment; and
determine an effect of the selected ransomware variant on the enterprise replica based on analyzing the kernel telemetry data.

14. The computer system of claim 13, wherein the kernel telemetry data associates, for each system call of the plurality of system calls, a process invoking the system call, an operation type of the system call, and a target of the system call.

15. The computer system of claim 13, wherein the instructions, when executed by the one or more processors, cause the one or more processors to:
generate a second enterprise replica in a second isolated test environment by provisioning the one or more server systems and deploying the one or more enterprise applications with at least one configuration difference from the enterprise replica;
deploy the kernel monitoring component and the selected ransomware variant in the second isolated test environment. the kernel monitoring component configured to generate second kernel telemetry data for a second plurality of system calls initiated by processes executing on the one or more server systems in the second isolated test environment;
determine a second effect of the selected ransomware variant on the enterprise replica in the second isolated test environment based on analyzing the second kernel telemetry data; and
identify a set of differences between the effect and the second effect that are attributable to the at least one configuration difference.

16. The computer system of claim 15, wherein the at least one configuration difference comprises deploying a ransomware defense component on at least one of the one or more server systems in the second isolated test environment.

17. The computer system of claim 13, wherein the instructions, when executed by the one or more processors, cause the one or more processors to:
deploy a ransomware defense component on at least one of the one or more server systems in the isolated test environment, the ransomware defense component configured to:
analyze the kernel telemetry data;
based on analyzing the kernel telemetry data, determine that a particular process executed under control of a ransomware agent; and
in response to determining that the particular process executed under control of the ransomware agent, initiate one or more response measures.

18. The computer system of claim 13, wherein the instructions, when executed by the one or more processors, cause the one or more processors to:
determine one or more resource dependencies of the one or more enterprise applications;
obtain a set of resources to deploy in the isolated test environment based on the one or more resource dependencies; and
deploy the set of resources in the isolated test environment.

19. The computer system of claim 18, wherein determining the one or more resource dependencies comprises:
deploying the kernel monitoring component on one or more production server systems running the one or more applications, wherein the kernel monitoring component generates production kernel telemetry data for a second plurality of system calls initiated by processes executing on the one or more production server systems;
wherein determining the one or more resource dependencies is based on the production kernel telemetry data.

20. The computer system of claim 18, wherein determining the one or more resource dependencies comprises:
deploying one or more test server systems running the one or more applications in an application evaluation environment; and
deploying the kernel monitoring component on the one or more test server systems, wherein the kernel monitoring component generates test kernel telemetry data for a third plurality of system calls initiated by processes executing on the one or more test server systems;
wherein determining the one or more resource dependencies is based on the test kernel telemetry data.
